(19) United States
(12) Patent Application Publication
(10) Pub. No.: US 2014/0074586 A1
(43) Pub. Date: Mar. 13, 2014

(54) EQUILIBRIUM ALLOCATION FOR BUDGET SMOOTHING IN SEARCH ADVERTISING

(71) Applicants: Nikhil Devanur Rangarajan, Bellevue, WA (US); Lei Wang, Bellevue, WA (US); Deeparnab Chakrabarty, Bangalore (IN); David Maxwell Chickering, Bellevue, WA (US); Denis Xaiver Charles, Bellevue, WA (US)

(72) Inventors: Nikhil Devanur Rangarajan, Bellevue, WA (US); Lei Wang, Bellevue, WA (US); Deeparnab Chakrabarty, Bangalore (IN); David Maxwell Chickering, Bellevue, WA (US); Denis Xaiver Charles, Bellevue, WA (US)

(73) Assignee: Microsoft Corporation, Redmond, WA (US)

(21) Appl. No.: 13/610,863

(22) Filed: Sep. 12, 2012

(51) Int. Cl. G06Q 30/02

(52) U.S. Cl. 705/14.41; 705/14.71; 705/14.54

(57) ABSTRACT

Various technologies described herein pertain to smoothing budgets of advertisers in online advertising. Information that indicates respective budgets of advertisers for online advertising during a time period and bids for auctions during the time period from the advertisers can be received. Moreover, a determination concerning whether to either throttle an advertiser from an auction or permit the advertiser to participate in the auction can be effectuated for each of the auctions during the time period and for each of the advertisers. The determination satisfies equilibrium conditions between the advertisers based on the respective budgets of the advertisers and the bids of the auctions. Moreover, winning bids for the auctions during the time period are determined. The winning bids can be determined from the bids of the advertisers respectively permitted to participate in each of the auctions.

### BACKGROUND

In search advertising, advertisers commonly set respective budgets to be spent in auctions during a period of time (e.g., $X for a day, week, month, year, or substantially any other period of time). However, the budgets of advertisers oftentimes run out before the time period ends. Accordingly, it is desirable to smooth out the budgets of the advertisers over the time period. Such smoothing can be achieved, for instance, by restricting participation (e.g., throttling) of such advertisers from a subset of auctions.

Various conventional approaches have attempted to select auctions out of which to throttle advertisers. One such conventional approach is random throttling. With random throttling, a probability parameter pᵢ is evaluated for each advertiser i, and such advertiser is throttled out of each auction independently with probability pᵢ. Such probability pᵢ can relate to a rate at which the advertiser i is overspending. For instance, if in the previous week (considering budgets for a time period having a duration of a week) a budget of the advertiser i is exhausted by mid-week, then the probability can be set to pᵢ=1/2 for the current week.

According to an example where random throttling is employed, consider a scenario where one advertiser has a budget of $100 and participates in two auctions (e.g., two generalized second-price auctions (GSPs)), each having a reserve price of $1. Following this example, the advertiser bids $1 in the first auction and bids $100 in the second auction. Suppose there are 100 instances of each auction during a time period. Further, assume that other advertisers are not participating in the two auctions. Pursuant to this example, the budget of the advertiser can be exhausted halfway through the time period that covers the 100 instances of each auction; accordingly, the probability can be set to pᵢ=1/2. Thus, the advertiser can be throttled out of each of the two auctions independently with probability pᵢ=1/2. In accordance with this example, random throttling can cause the advertiser to participate in 50 of the 100 instances of each of the two auctions. Yet, based on the bids of the advertiser, it may be desirable to cause the advertiser to participate in none of the instances of the first auction and 100 instances of the second auction. However, with random throttling, bids of advertisers are not considered when distinguishing between auctions from which to throttle advertisers. Thus, random throttling can incentivize an advertiser to discontinue bidding on lower value auctions (e.g., in the foregoing example the advertiser has an incentive to discontinue bidding on the first auction since the advertiser places a higher value on the second auction as evinced by the higher bid in the second auction).

Other approaches can perform throttling decisions that attempt to optimize factors such as social welfare or revenue. According to an example where a social welfare maximization approach is utilized, consider a scenario where two advertisers (advertiser A1 and advertiser A2) participate in an auction (e.g., GSP) with budgets $5 and $100, respectively. Following this example, suppose the reserve price for the auction is 5 cents, and there are 100 instances of the auction during a time period. Advertiser A1 bids $5 and advertiser A2 bids $4. In the social welfare maximization approach, advertiser A2 is throttled from participating in the auction, thereby allowing advertiser A1 to win the 100 instances of the auction at the reserve price of 5 cents per instance. Accordingly, prices are kept artificially low to maximize welfare in such approach. However, revenues of the auctioneer may be impacted by this approach.

By way of another example where a revenue maximization technique is employed, consider a scenario with three advertisers: advertiser A1, advertiser A2, and advertiser A3. Advertiser A1 has an unlimited budget (budget of ∞), advertiser A2 has a budget of $100, and advertiser A3 has an unlimited budget (budget of ∞). Moreover, pursuant to this example, suppose there are two auctions: auction I1 and auction I2. Each of the auctions has two slots. Auction I1 has a reserve price of $2 and auction I2 has a reserve price of $1, and there are 100 instances of each of the auctions during a time period. Following this example, advertiser A 1 bids $4 on auction I/1 and nothing on auction I2. Moreover, advertiser A2 bids $3 on auction I/1 and $100 on auction I2, that is advertiser A2 prefers auction I2 to auction I/1. Further, advertiser A3 bids $2 on auction I2 and nothing on auction I/1. In the revenue maximization approach, advertiser A2 participates in auction I/1 to maximize an amount of revenue received by the auctioneer from advertiser A1, where advertiser A1 has an unlimited budget. To provide that advertiser A2 continues to participate in auction I/1 (e.g., for the 100 instances of auction I/1), advertiser A2 can be throttled out of auction I2. Moreover, the amount of revenue received from advertiser A3 for the 100 instances of auction I2 is not affected by whether advertiser A2 participates in auction I2. Accordingly, with advertiser A2 throttled out of auction I2, revenue received by the auctioneer can be maximized (e.g., $300 can be received from advertiser A1 based on the $3 bid by advertiser A2, $200 can be received from advertiser A2 based on the $2 reserve price for auction I/1, and $100 can be received from advertiser A3 based on the $1 reserve price for auction I2). However, such approach can be unfair to advertiser A2 (e.g., since advertiser A2 expressed a preference for auction I2 based on the $100 bid), and thus, advertiser A2 is likely to leave the system if throttled out of auction I2 as set forth above.

### SUMMARY

Described herein are various technologies that pertain to smoothing budgets of advertisers in online advertising. Information that indicates respective budgets of advertisers for online advertising during a time period and bids for auctions during the time period from the advertisers can be received. Moreover, a determination concerning whether to either throttle an advertiser from an auction or permit the advertiser to participate in the auction can be effectuated for each of the auctions during the time period and for each of the advertisers. The determination satisfies equilibrium conditions between the advertisers based on the respective budgets of the advertisers and the bids of the auctions. Moreover, winning bids for the auctions during the time period are determined. The winning bids can be determined from the bids of the advertisers respectively permitted to participate in each of the auctions.

In various embodiments, the throttling/participation decision can be made based on respective threshold minimum return on investment values for the advertisers. The respective threshold minimum return on investment values can be received (e.g., retrieved from a data repository, etc.), computed, adjusted (e.g., periodically, continuously), and so forth. Moreover, participation profiles for each of the auctions can be determined based at least in part on the respective threshold minimum return on investment values for the advertisers and the bids for the auctions from the advertisers. For instance, a participation profile for a particular auction includes a first subset of the advertisers that participate in the particular auction and excludes a second subset of the advertisers throttled from the particular auctions.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates a functional block diagram of an exemplary system that facilitates smoothing budgets of advertisers for online advertising during a time period.

FIG. 2 illustrates a functional block diagram of an exemplary system that determines participation profiles for auctions.

FIG. 3 illustrates a functional block diagram of an exemplary system that computes threshold minimum return on investment values for advertisers utilized to determine participation profiles for auctions.

FIG. 4 illustrates an exemplary graphical user interface that presents advertisements in advertising positions.

FIG. 5 is a flow diagram that illustrates an exemplary methodology for budget smoothing in online advertising.

FIG. 6 is a flow diagram that illustrates an exemplary methodology that facilitates smoothing budgets of advertisers based on minimum return on investment values for the advertisers.

FIG. 7 illustrates an exemplary computing device.

### DETAILED DESCRIPTION

Various technologies pertaining to smoothing budgets of advertisers during a time interval based on an equilibrium allocation between advertisers are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

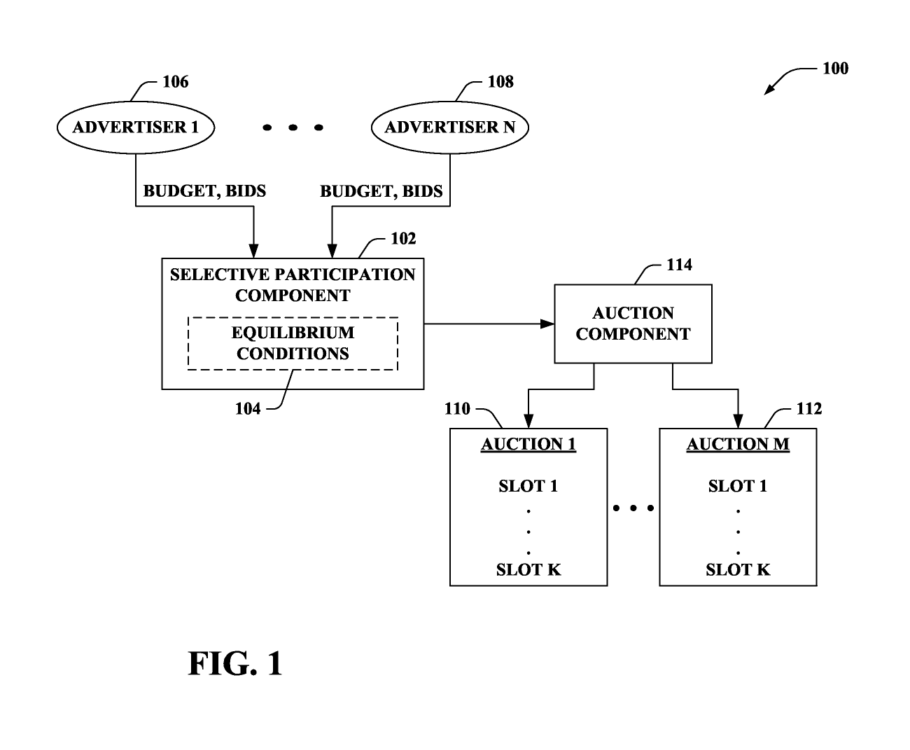

Referring now to the drawings, FIG. 1 illustrates a system 100 that facilitates smoothing budgets of advertisers for online advertising during a time period. The system 100 includes a selective participation component 102 that determines whether to throttle advertisers from auctions or permit the advertisers to participate in the auctions. Determinations concerning whether to throttle the advertisers or permit the advertisers to participate in the auctions are made by the selective participation component 102 to satisfy equilibrium conditions 104 between the advertisers.

As used herein, the term “throttle” is intended to mean “restrict from participating.” Moreover, as used herein, the term “auctioneer” is intended to encompass an owner of an item that is available by way of auction. For example, a search engine may comprise the system 100, and the search engine may be the auctioneer for the auctions. According to another example, an exchange for display advertising may be the auctioneer for the auctions. Further, various types of online advertising are intended to fall within the scope of the hereto appended claims; examples of online advertising types include, but are not limited to, search-based keyword advertising, banner advertising, social network advertising, interstitial advertising, and the like.

The system 100 includes N advertisers, namely, advertiser 1 106, . . . , and advertiser N 108, where N can be substantially any integer greater than 1 (collectively referred to herein as advertisers 106-108). Moreover, the system 100 includes M auctions, namely, auction 1 110, . . . , and auction M 112, where M can be substantially any integer greater than 1 (collectively referred to herein as auctions 110-112). The auctions 110-112, for example, can be generalized second-price auctions, Vickrey-Clarke-Groves auctions, or the like.

The selective participation component 102 can receive information that indicates respective budgets of the advertisers 106-108 for online advertising during a time period. It is contemplated that the budgets can be for a time period having substantially any duration (e.g., day, week, month, year, etc.). Moreover, the selective participation component 102 can receive bids for the auctions 110-112 during the time period from the advertisers 106-108. According to various examples, the selective participation component 102 can receive the information that indicates the respective budgets and/or the bids from the advertisers 106-108 (e.g., via any type of user interface), from a data repository (not shown) that retains the budget information and/or bids, a combination thereof, and so forth.

The selective participation component 102 can determine whether to throttle an advertiser from an auction or permit the advertiser to participate in the auction. Such determination can be made by the selective participation component 102 for each of the auctions 110-112 during the time period and for each of the advertisers 106-108. By way of example, for a given auction j (e.g., where auction j is in the set of auctions 110-112), the selective participation component 102 can permit a first subset of the advertisers 106-108 to participate in such auction j. Following the foregoing example, the selective participation component 102 can throttle a second subset of the advertisers 106-108 from the auction j. The determination effectuated by the selective participation component 102 satisfies the equilibrium conditions 104 between the advertisers 106-108 based on respective budgets of the advertisers 106-108 and the bids for the auctions 110-112; thus, the determination provides an equilibrium allocation of advertisers permitted to participate in each of the auctions 110-112.

The equilibrium conditions 104 between the advertisers 106-108 can be based on the notion of the Nash equilibrium from game theory. The equilibrium conditions 104 support various properties that provide stability within the system 100 (e.g., the properties support long term participation of the advertisers 106-108). More particularly, the equilibrium conditions 104 provide for not throttling an advertiser out of an auction during a time period if a budget of the advertiser during that time period is not expected to be exhausted. Further, for a budget constrained advertiser (e.g., an advertiser expected to exhaust a corresponding budget during the time period), the equilibrium conditions 104 can provide for throttling the advertiser from auction(s) that give lower returns on investment as compared to auction(s) in which budget is spent (e.g., thereby mitigating the advertiser from feeling unfairly throttled and/or having an incentive to alter the throttle/participate decision made by the selective participation component 102). Thus, given the equilibrium conditions 104, the selective participation component 102 does not throttle an advertiser with remaining budget to spend, and throttling decisions for budget constrained advertisers made by the selective participation component 102 can maximize returns on investment given actions of other advertisers.

The system 100 further includes an auction component 114 that determines winning bids for the auctions 110-112 during the time period. The winning bids can be determined by the auction component 114 from the bids of the advertisers 106-108 respectively permitted to participate in each of the auctions 110-112. For instance, each of the auctions 110-112 can have K slots (e.g., slot 1, . . . , slot K for auction 1 110, etc.), where K can be substantially any integer equal to or greater than 1. Accordingly, the number of winning bids identified by the auction component 114 for each of the auctions 110-112 can be less than or equal to K (e.g., depending upon a respective number of bids from advertisers 106-108 permitted to participate and a respective reserve price for each of the auctions 110-112). Although many of the examples set forth herein describe each of the auctions 110-112 having a common number of slots (e.g., K slots), it is contemplated that different auctions can have differing numbers of slots (e.g., auction 1 110 can have five slots and auction M 112 can have ten slots, etc.).

As noted above, the determination whether to throttle an advertiser from an auction or permit the advertiser to participate in the auction made by the selective participation component 102 satisfies the equilibrium conditions 104 between the advertisers 106-108 based on the respective budgets of the advertisers 106-108 and the bids for the auctions 110-112. For example, the equilibrium conditions 104 can include that the advertiser is expected to spend less than or equal to a respective budget during the time period on a subset of the auctions in which the advertiser is permitted to participate and has a winning bid; accordingly, such condition can maintain feasibility. The equilibrium conditions 104 can also include that the advertiser is permitted to participate in the auction when the advertiser is expected to spend less than the respective budget during the time period; thus, such condition can provide for maximal participation of the advertiser. Moreover, the equilibrium conditions 104 can include that the advertiser is permitted to participate in the auction when the advertiser is expected to exhaust the respective budget and disparate auctions from which the advertiser is throttled provide lower returns on investment for the advertiser. Further, the equilibrium conditions 104 can include that the advertiser is throttled from the auction when the advertiser is expected to exhaust the respective budget during the time period and disparate auctions in which the advertiser is permitted to participate provide higher returns on investment for the advertiser.

The system 100 can further be described as follows. Let N be the number of advertisers 106-108 and M be the number of auctions 110-112. Advertiser is in the set of N advertisers 106-108, thus, advertiser i∈[N]. Further, auction j is in the set of M auctions 110-112, accordingly, auction j∈[M]. Advertiser i has a budget Bᵢ, bid bᵢ(j) and probability of click value (p-click) pᵢ(j) for auction j∈[M]. A score of advertiser i for auction j can be denoted as vᵢ(j)=bᵢ(j)pᵢ(j). Each auction j∈[M] has a reserve price of rⱼ.

As noted above, the selective participation component 102 determines a subset of the advertisers 106-108 that can participate in auction j; such subset of the advertisers 106-108 is represented as Sⱼ, where Sⱼ⊂[N]. Further, a disparate subset of the advertisers 106-108 can be throttled from the auction j by the selective participation component 102; accordingly, if an advertiser i∉Sⱼ, then such advertiser i has been throttled from auction j. The vector {Sᵢ: j∈[M]} can be referred to as a participation profile (e.g., participation set).

Each of the auctions 110-112 can have K slots, that is, there can be K winners for each of the auctions 110-112. Let θₖ be the position factor of slot k. In the jth auction, the auction component 114 executes a generalized second-price auction (GSP) on the set Sⱼ of bidders. More particularly, the auction component 114 sorts the scores vᵢ (j) for i∈Sⱼ; in decreasing order to get {vᵢ_{₁}(j)>vᵢ_{₂}(j)> . . . >vᵢ_{ᵣ}(j)≧rⱼ}. The auction component 114 awards the K slots for the auction j to i₁, . . . , iᵣ and bidder iₗ, for 1≦l≦K, pays in expectation θₗvᵢ_{ₗ₊₁}(j). If r≦K, then fewer than K slots are awarded and the ‘last’ winner pays θₗrⱼ in expectation. Let s (i, j) denote the expected spend of advertiser i from auction j. It is assumed that the utility of advertiser i on winning slot k of auction j is θₖvᵢ(j). A return on investment (ROI) for advertiser iₗ, where l≦K, is thus

$$\frac{{v}_{{i}_{l}} ( j )}{{v}_{{i}_{l + 1}} ( j )} .$$

Accordingly, ROI(i, Sⱼ) denotes the ROI of advertiser i from auction j when the participation profile is Sⱼ; ROI(i, Sⱼ) is set to 0 if advertiser i does not win any of the K slots of auction j. Moreover, a minimum return on investment for advertiser i (minROI(i)) is a minimum taken over all auctions where i is a winner. Further, spend(i):=Σ_{j∈[M]}s(i,j).

According to an example, a participation profile can satisfy the equilibrium conditions 104 if the following properties hold:

1. Feasibility: spend(i) Bᵢ.

2. Maximal Participation: If spend(i)<Bᵢ, then i∈Sⱼ for all j.

3. Optimal Throttling: If∉Sⱼ, then ROI(i, Sⱼ∪i) is at most minROI(i).

In the foregoing, the first property maintains feasibility. The second property provides that if an advertiser does not exhaust his budget, then that advertiser is not throttled. The third property provides that any auction from which an advertiser has been throttled provides less ROI than the auctions in which that advertiser participates and wins (and therefore spends money). Note that if the optimal throttling property and the maximal participation property are met, then each of the advertisers 106-108 participate in their most profitable auctions given the participations of other advertisers 106-108.

By way of another example, participation profiles can be randomized. Following this example, for each auction j, instead of a single participation profile Sⱼ, there can be a distribution Sⱼ on participation profiles. Accordingly, equilibrium participation can be based on the following properties. Moreover, in the following, for minROI(i), the minimum is taken over all participation profiles S in support of various Sⱼ.

Pursuant to this example, a participation profile (e.g., a fractional participation profile) can satisfy the equilibrium conditions 104 if the following properties hold:

1. Feasibility: Exp[spend(i)]≦Bᵢ for all i.

2. Maximal Participation: If Exp[spend(i)]<Bᵢ, then for all j, for all S in support of Sⱼ, i∈S.

3. Optimal Throttling: If i∉S for some Sin support of Sⱼ for some j, then the ROI obtained by i in S∪i is at most minROI(i).

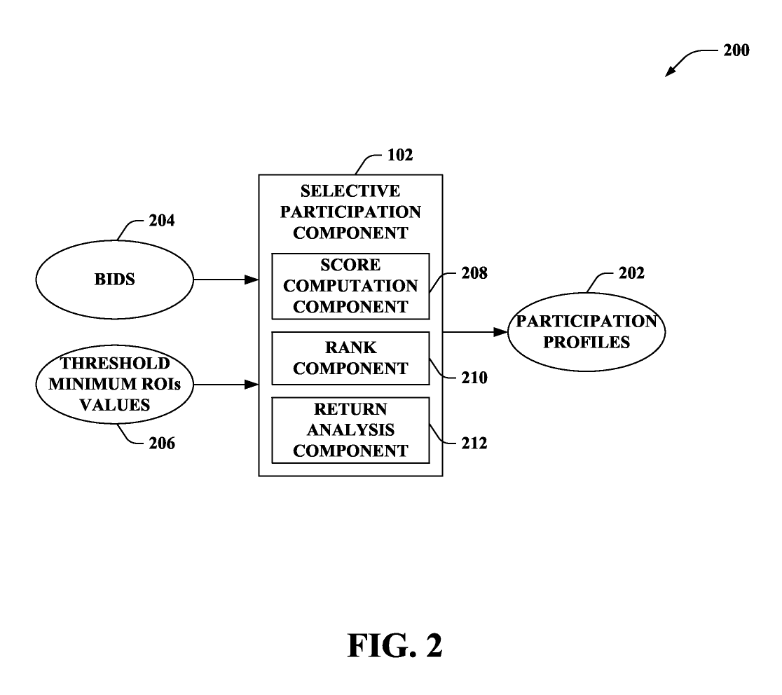

Now turning to FIG. 2, illustrated is a system 200 that determines participation profiles 202 for the M auctions (e.g., the auctions 110-112 of FIG. 1). A participation profile for a particular auction includes a first subset of advertisers that participate in the particular auction and excludes a second subset of the advertisers throttled from the particular auction.

The system 200 includes the selective participation component 102. The selective participation component 102 can receive bids 204 for the M auctions from the N advertisers (e.g., the advertisers 106-108 of FIG. 1). Moreover, the selective participation component 102 receives respective threshold minimum return on investment values 206 for the advertisers, represented as αᵢ for advertiser i, where advertiser i∈[N]. For example, the threshold minimum return on investment values 206 can be retrieved from a data repository or the like. However, according to other examples, it is contemplated that the selective participation component 102 can calculate the threshold minimum return on investment values 206 (e.g., initially compute the threshold minimum return on investment values 206, continually or periodically update the threshold minimum return on investment values 206 over time, etc.).

The selective participation component 102 can include a score computation component 208 and a rank component 210. Based on the bids 204 (and p-click values which can also be received by the selective participation component 102), the score computation component 208 can calculate a score for advertiser i for auction j as vᵢ(j)=bᵢ(j)pᵢ(j). Moreover, the rank component 210 can sort the scores vᵢ(j) in decreasing order for auction j to obtain v₁(j)>v₂(j)> . . . >vₗ(j)>rⱼ (referred to herein as a decreasing order of scores), where rⱼ is a reserve price for the auction j. According to another example, it is contemplated that the auction component 114 of FIG. 1 can include the score computation component 208 and the rank component 210; following this example, the auction component 114 can provide the scores as sorted in decreasing order to the selective participation component 102.

Moreover, the selective participation component 102 can include a return analysis component 212 that calculates returns on investment based on the scores as sorted in decreasing order. Further, the selective participation component 102 can compare the returns on investment computed by the return analysis component 212 to the threshold minimum returns on investment values 206 to determine whether to throttle advertisers from auctions or permit advertisers to participate in auctions.

Thus, the selective participation component 102 can determine whether to throttle an advertiser i or permit the advertiser i to participate in an auction j based on a threshold minimum return on investment value for the advertiser i, which is included in the threshold minimum return on investment values 206. Accordingly, the return analysis component 212 can permit the advertiser i to participate in a first subset of the M auctions, wherein auctions in the first subset that the advertiser i wins each provide the advertiser i with a return on investment as computed by the return analysis component 212 greater than the threshold minimum return on investment value for the advertiser i. Further, the selective participation component 102 can throttle the advertiser i from a second subset of the M auctions, wherein auctions in the second subset from which the advertiser i is throttled each provide the advertiser i with a return on investment computed by the return analysis component 212 lower than or equal to the threshold minimum return on investment value for the advertiser i. Thus, the selective participation component 102 can determine the participation profiles 202 for each of the M auctions based at least in part on the respective threshold minimum return on investment values 206 and the bids 204 for the M auctions from the N advertisers. The participation profiles 202 determined by the selective participation component 102 satisfy the equilibrium conditions between the advertisers.

More particularly, in the system 200, each advertiser i is assigned a parameter αᵢ≧1, which denotes a lower bound on the minROI of this advertiser, also referred to herein as the threshold minimum return on investment value. The selective participation component 102 executes the throttle/participation decisions to provide that auctions that the advertiser i wins have returns on investment computed by the return analysis component 212 of at least αᵢ. Further, the selective participation component 102 executes the throttle/participation decisions to provide that auctions in which the advertiser i does not participate have returns on investment computed by the return analysis component 212 of at most αₗ assuming that the advertiser instead participated in such auctions.

Accordingly, given α:=(α₁, α₂, . . . , αₙ), a participation profile {S₁, . . . , S_{M}} respects thresholds a for each advertiser i∈[N] and each auction j∈[M]:

If i∈Sⱼ then ROI(i,Sⱼ)=0 or ROI(i,Sⱼ)>αᵢ; and

If i∉Sⱼ, then ROI(i,Sⱼ∪αᵢ.

Observe that if a participation profile respects thresholds a, for any a, then the optimal throttling condition is satisfied.

Below is exemplary pseudocode for determining a participation profile. The pseudocode can represent a procedure referred to herein as ReturnParticipationSet (j). Such procedure can be executed by the selective participation component 102 (e.g., at least a portion of the procedure can be executed by the return analysis component 212). Inputs include the scores sorted in decreasing order for an auction j (e.g., generated by the score computation component 208 and sorted by the rank component 210) and the threshold minimum return on investment values 206, referred to as α. Moreover, a participation profile that respects α is outputted. It is to be appreciated that such pseudocode is presented for illustration purposes, and the claimed subject matter is not so limited.

| | |
|---|---|
| 1: | Input: v₁(j) > v₂(j) > . . . > vₗ(j) > rⱼ |
| | (α₁, α₂, . . . , αₙ); aᵢ ≧ 1. |
| 2: | Output: Sⱼ: an α-respecting participation profile for auction j. |
| 3: | Given α evaluate the mapping σ as described above: |
| | $σ ( i ) = min {i}^{′} s . t . \frac{{v}_{i} ( j )}{{v}_{{i}^{′}} ( j )} > {α}_{i} ; σ ( i ) = ∞ if \frac{{v}_{i} ( j )}{{r}_{j}} \leq {α}_{i}$ |
| 4: | current.min = ∞ |
| 5: | for i = N → 1 do |
| 6: | if σ(i) < current.min then |
| 7: | Sⱼ = Sⱼ ∪ i. |
| 8: | current.min = σ(i) |
| 9: | end if |
| 10: | end for |

The foregoing pseudocode is for a given auction j. The advertisers are renumbered (e.g., by the rank component 210) so that v₁ (j)>v₂(j)> . . . >vₗ(j)>rⱼ. Note that for any advertiser i, vᵢ(j)/v_{i′}(j)<vᵢ(j)v_{i″(j) if v}_{i′}(j)>v_{i″}(j). Given α, a mapping σ:[N] [symbol] [N] is defined at line 3 as follows: for all i′<σ(i), vᵢ(j)/v_{i′(j)≦α}ᵢ and vᵢ(j)/v_{σ(i)}(j)>αᵢ. If vᵢ(j)/rⱼ<αᵢ, let σ(i)=∞. Note that σ(i)≧(if αᵢ1). In lines 4-10, the mapping generated at line 3 is used to identify a subset of the advertisers to include in a participation profile S. Further, in a participation profile Sⱼ respecting α, if i∈Sⱼ then no advertiser strictly between i and σ(i) can be present in Sⱼ.

The participation profile returned by the aforementioned pseudocode is an α-respecting set. According to an example, when an advertiser i is being considered, current.min points to an advertiser i′ who is present in Sⱼ such that no advertiser strictly between i and i′ is present. Therefore, if the advertiser i were to be included in Sⱼ and advertiser i were to win a slot of the auction j, the ROI for the advertiser i would be vᵢ(j)/v_{i′(j). If i∉S}ⱼ, the σ(i)≧i′ or equivalently the ROI of i in Sⱼ∪i would be ≦αᵢ. If i∈Sⱼ, the ROI of advertiser i is either 0 (e.g., if the advertiser i does not win any slot of the auction j) or >αᵢ since i′>σ(i). In either case, the final Sⱼ is α-respecting.

According to an example, a participation profile for a particular auction j can be determined (e.g., by the selective participation component 102) as follows. The score computation component 208 can calculate scores for each of the advertisers as a function of the bids 204 for the particular auction j from the advertisers. By way of example, the scores calculated by the score computation component 208 can further be a function of probability of click values of the advertisers for the particular auction j. According to another example, it is contemplated that the selective participation component 102 can receive the scores for each of the advertisers (e.g., rather than calculating the scores with the score computation component 208).

Whether computed by the score computation component 208 or received by the selective participation component 102, the rank component 210 can receive the scores for each of the advertisers. Further, the rank component 210 can rank the scores that are greater than a reserve price rⱼ for the particular auction j in a decreasing order of scores. Moreover, the selective participation component 102 can generate a mapping from the decreasing order of scores. Further, the selective participation component 102 can determine a subset of the advertisers that participate in the particular auction j based on the mapping. According to an illustration, for each score in the decreasing order of scores from a lowest score to a highest score, the selective participation component 102 can generate a mapping for an advertiser i corresponding to such score and compare the mapping for the advertiser i to a current minimum value; if the mapping for the advertiser i is less than the current minimum value, the selective participation component 102 can add the advertiser i to the subset of the advertisers that participate in the particular auction j and set the mapping for the advertiser i as the current minimum value.

As provided above, the mapping can be a function of the respective minimum threshold values 206 for the advertisers and returns on investment computed by the return analysis component 212 from scores in the decreasing order. As noted above, the mapping can be generated as part of the foregoing iterative approach for each score in the decreasing order of scores utilizing the following algorithm:

$$σ ( i ) = min {i}^{′} s . t . \frac{{v}_{i} ( j )}{{v}_{{i}^{′}} ( j )} > {α}_{i} ; σ ( i ) = ∞ if \frac{{v}_{i} ( j )}{{r}_{j}} \leq {α}_{i}$$

In the foregoing, σ(i) is a mapping for an advertiser i to one of infinity or an advertiser i′. Further, vᵢ (j) is a score for the advertiser i for an auction j and v_{i′}(j) is a score for the advertiser i′ for the auction j, wherein the score for the advertiser i for the auction j is greater than the score for the advertiser i′ for the auction j in the decreasing order of scores. Moreover, αᵢ is a threshold minimum return on investment value for the advertiser i, and the advertiser i′ is associated with a maximum score within the decreasing order of scores that provides a return on investment greater than the threshold minimum return on investment for the advertiser i.

According to an illustration, given a, a participation profile which is α-respecting can be identified, and such participation profile can satisfy the optimal throttling property. Also, note that if αᵢ=1 for an advertiser, then such advertiser can participate in auctions without throttling. However, a resulting profile need not be feasible. Therefore, for example, an equilibrium participation profile can be obtained if αᵢ's can be found such that the resulting participation profile is feasible with αᵢ=1 for advertisers i whose spends are smaller than their budgets.

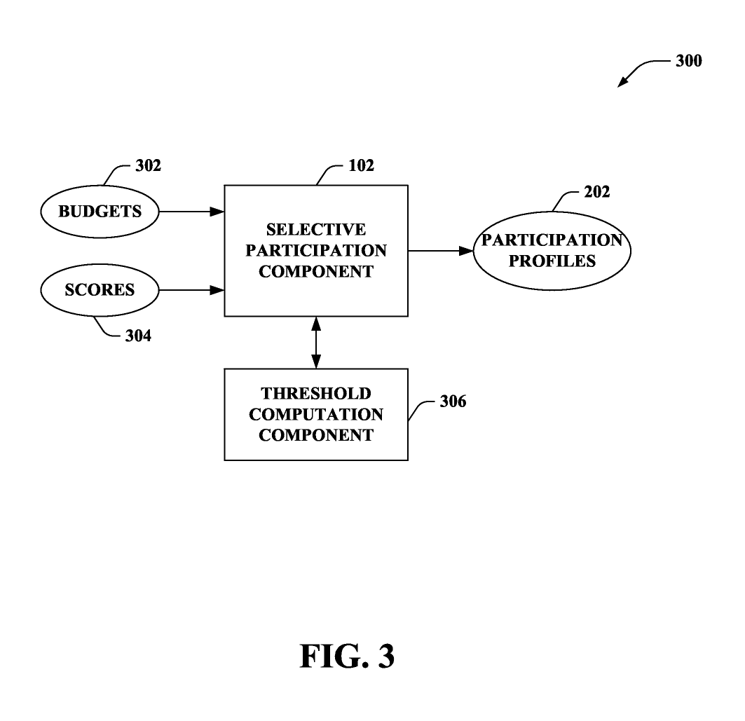

Turning now to FIG. 3, illustrated is a system 300 that computes threshold minimum return on investment values for advertisers utilized to determine the participation profiles 202 for auctions. The system 300 includes the selective participation component 102. The selective participation component 102 can receive budgets 302 of the advertisers. Further, the selective participation component 102 can receive scores 304 (e.g., decreasing order of scores). Yet, it is also contemplated that the selective participation component 102 can include the score computation component 208 and the rank component 210 of FIG. 2, and thus, can generate the scores 304 (e.g., based on bids of the advertisers and p-click values).

The system 300 further includes a threshold computation component 306. The threshold computation component 306 can adjust respective threshold minimum return on investment values for the advertisers based on actual spend rates versus ideal spend rates for the advertisers. Moreover, the threshold computation component 306 can set initial respective threshold minimum return on investment values for the advertisers.

Below is exemplary pseudocode for an online budget smoothing heuristic. The following can be executed, for instance, by the system 300. However, it is to be appreciated that such pseudocode is presented for illustration purposes, and the claimed subject matter is not so limited.

| | |
|---|---|
| 1: | Input: Scores and T-interval budgets of advertisers [N]. (T: week/ |
| | month). Queries (auctions) coming online form a set [M]. |
| 2: | Assumptions: Queries come i.i.d. from some underlying distribution. |
| 3: | Output: For each auction j, participation profile Sⱼ on which GSP is |
| | run. |
| 4: | Parameters: ε (granularity parameter), η_{i,r} (growth parameter) |
| 5: | Initialize all αᵢ = 1, spend(i) = 0. |
| 6: | Evaluate for each advertiser i possible ROI's, that is, all possible |
| | vᵢ(j)/v_{i′}(j) over all i′ ∈ [N] and j ∈ [M]. Let this range for advertiser i |
| | be [1, Lᵢ]. This sets the domain of αᵢ. |
| 7: | for r = 0 → └T/ε┘ do |
| 8: | for t = r┌εT┐ → (r + 1)┌εT┐ do |
| 9: | Run ReturnParticipationSet(jₜ) with input α; {jₜ is auction at |
| | time t.} |
| 10: | Increment spend(i) for each advertiser i. |
| 11: | end for |
| 12: | Modify α's. Possible update rules include: |
| | $\begin{matrix}{α}_{i} \text{:} = {\prod }^{ } ( {α}_{i} + {η}_{i , r} ( spend ( i ) - ɛ {B}_{i} ) ) \\ {α}_{i} \text{:} = \prod ( {α}_{i} \cdot exp ( {η}_{i , r} \frac{spend ( i ) - ɛ {B}_{i}}{{B}_{i}} ) )\end{matrix}$ |
| 13: | end for |

In the foregoing pseudocode at line 1, inputs include the scores 304 for the advertisers, the budgets 302 of the advertisers, and the N auctions. As described herein, the budgets 302 can be time interval budgets for the N advertisers, where the time interval can be substantially any duration (e.g., day, week, month, year, etc.). Moreover, the participation profiles 202 are generated as output (line 3). Various parameters can be set at line 4 such as a granularity parameter and a growth parameter. The granularity parameter, for instance, can pertain to a frequency at which the threshold minimum return on investment values are updated.

At line 5, the threshold minimum return on investment values for each of the advertisers and a spend amount for each of the advertisers is initialized. At line 6, possible return on investment values are evaluated (e.g., computed by the return analysis component 212 of FIG. 2). At lines 8-11, participation profiles can be determined (e.g., using the pseudocode described above in connection with FIG. 2) for a given time increment (e.g., having a duration corresponding to the granularity parameter) within the period of time and the spend amount for each of the advertisers can be updated. At line 12, the threshold minimum return on investment values for each of the advertisers can be adjusted. At line 12, exp represents the exponentiation function. Moreover, the foregoing can be repeated for each of the time increments within the period of time.

The following presents various features related to equilibrium participation profiles in general. It is to be appreciated, however, that the claimed subject matter is not limited to the following.

Equilibrium participation profiles exist. For instance, ReturnParticipationSet set forth above can be modified to return a distribution Sⱼ on sets. To do so, note that for each advertiser i there are Lᵢ≦NM possible ROI's that can be obtained from winning an auction. The possible ROI's are of the form

$$\frac{{v}_{i} ( j )}{{v}_{{i}^{′}} ( j )}$$

ranging over all j∈[M] and i′ such that vᵢ(j)>v_{i′}(j). Arrange these Lᵢ fractions in increasing order: let these be 1=f₀<f₁<f₂< . . . <f_{L}_{ᵢ} (these fractions can be indexed with a superscript i which is omitted for brevity). Now given αᵢ in [0, Lᵢ], a value q can be identified such that f_{q}<αᵢ≦f_{q+1}. The randomized distribution Sⱼ can be found as follows: for each i define the random variable α′ᵢ which is f_{q} with probability

$$p := \frac{{α}_{i} - {f}_{q}}{{f}_{q + 1} - {f}_{q}}$$

and f_{q+1} with probability (1−p). ReturnParticipationSet can be run with these αᵢ's, and the distribution on sets Sⱼ so obtained can be outputted. Let this randomized algorithm be called ReturnDistParticipation.

It can be observed that although ReturnDistParticipation returns a distribution, the optimal throttling condition is satisfied. This is because each (S₁, . . . , S_{M}) respects some (f_{q}⁽¹⁾, . . . , f_{q}⁽ⁿ⁾—thresholds where f_{q}⁽ⁱ⁾ s the lower bound on αᵢ. Further, if αᵢ is fixed for all advertisers but i, randomization makes Exp[spend(i)] a continuous function of αᵢ (in fact it is a piecewise linear function). Now given certain thresholds a, consider the mapping to get a new set of thresholds:

α′ᵢ:Π(αᵢ+η(Exp[spend(i)]−Bᵢ)) (1)

where 0<η<1 is any scalar, Exp[spend(i)] is the expected spend, and Π is the projection operator defined as Π(x)=x if x∈[0,Lᵢ], Π(x)=Lᵢ if x>Lᵢ and Π(x)=0 if x<0.

Putting it all together, a mapping φ from [0, Lᵢ]^{N} to [0, Lᵢ]^{N} which takes input (α₁, . . . , α_{N}) can be obtained. Further, the fractional participation profile as described above can be computed, the expected spends can be computed, (α′₁, . . . , α′_{N})∈[0,Lᵢ]^{N} can be returned using Equation (1) above. The domain of φ is closed and compact. φ is continuous because as defined Exp[spend(i)] is continuous function of the αᵢ's and the projection function is continuous. Therefore, by Brouwers fixed point theorem, a fixed point (α*₁, . . . , α*_{N}) can result.

Further, the fractional participation profile respecting (α*₁, . . . , α*_{N}) is in equilibrium. Moreover, for any bids, budgets, auctions and slots, an equilibrium fractional participation profile exists.

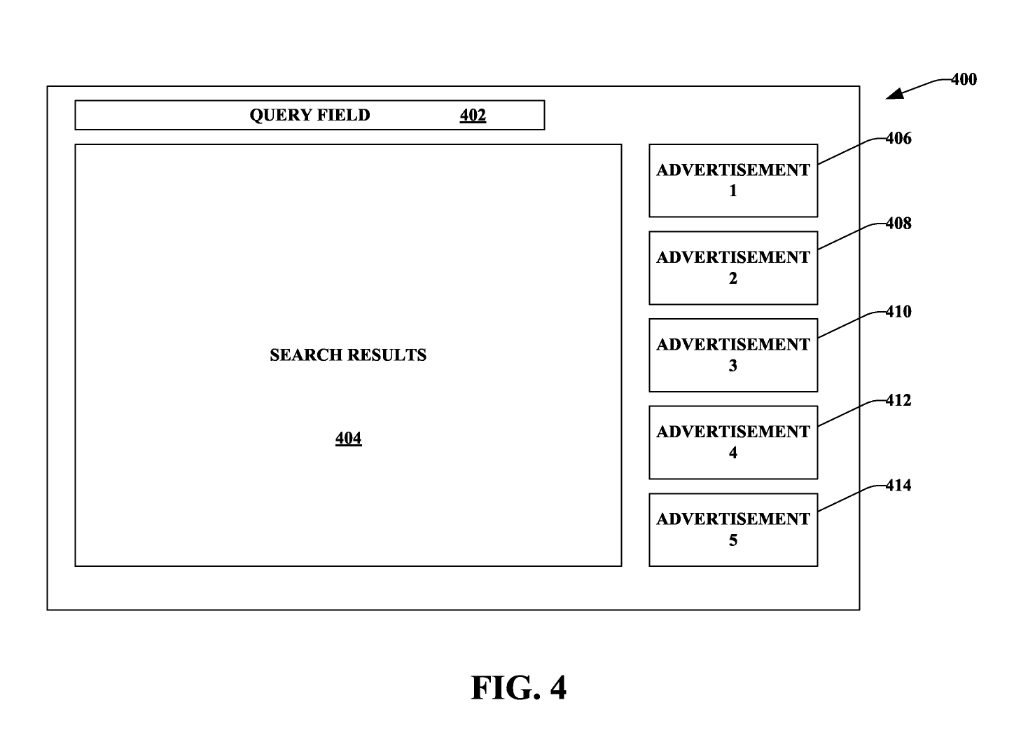

Turning now to FIG. 4, an exemplary graphical user interface 400 that presents advertisements in advertising positions is illustrated. The graphical user interface 400, for instance, can be rendered on a display screen (not shown) of a computing device (not shown). The advertisements can correspond to advertisers determined by the auction component 114 of FIG. 1 to have winning bids for a particular auction. The graphical user interface 400 includes a query field 402 that is configured to receive search queries (one or more keywords) from a user. The graphical user interface 400 also includes a search results field 404 that is configured to present a listing of search results to a user. The search results can comprise hypertext links to web pages, for instance. In another example, the search results may include images, video, or the like. The graphical user interface 400 additionally includes a plurality of advertisements 406-414 that are placed in particular positions (e.g., slots) in accordance with a ranking of scores of the winning bids by the auction component 114.

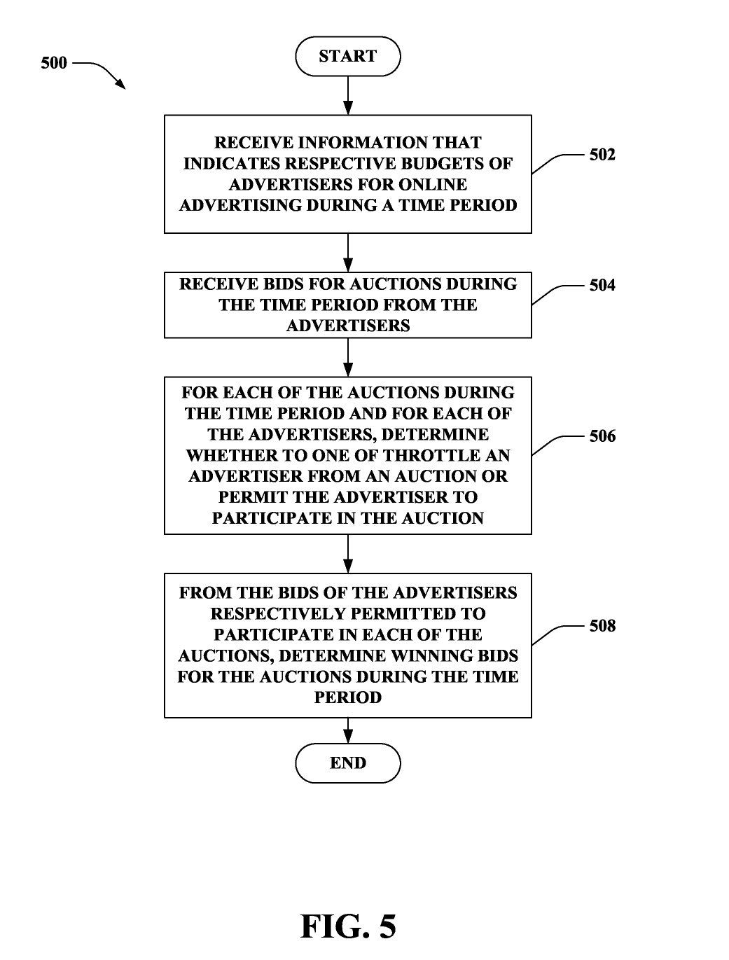

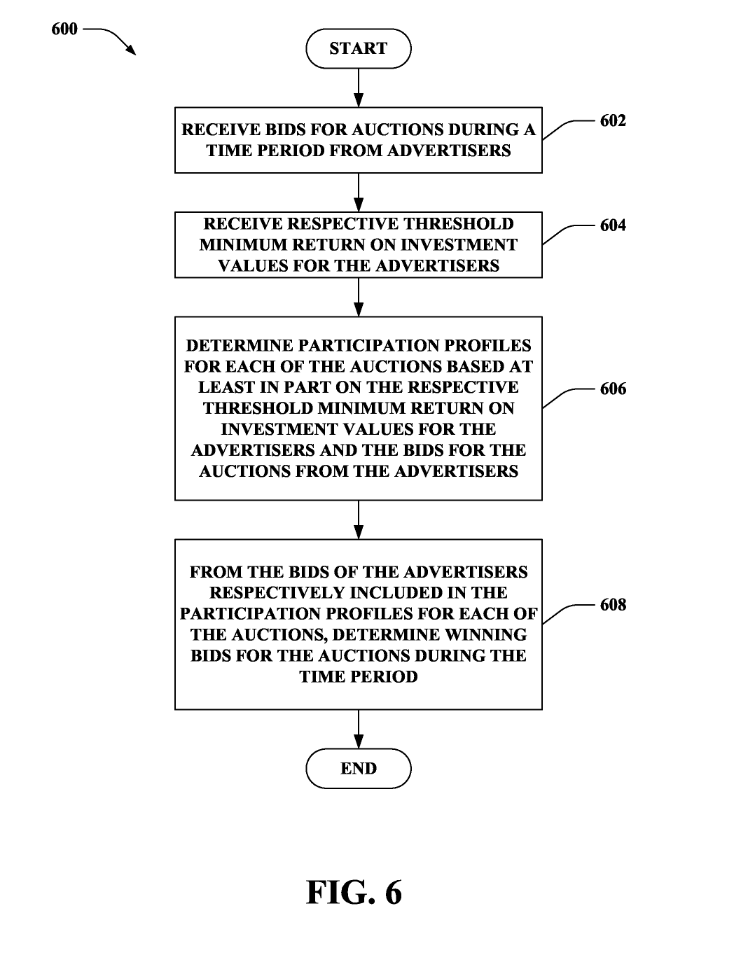

FIGS. 5-6 illustrate exemplary methodologies relating to budget smoothing in search advertising. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

FIG. 5 illustrates a methodology 500 for budget smoothing in online advertising. At 502, information that indicates respective budgets of advertisers can be received for online advertising during a time period. At 504, bids for auctions during the time period from advertisers can be received. At 506, a determination can be made concerning whether to one of throttle an advertiser from an auction or permit the advertiser to participate in the auction. Such determination can be made for each of the auctions during the period and for each of the advertisers. Moreover, the determination satisfies equilibrium conditions between the advertisers based on the respective budgets of the advertisers and the bids for the auctions. At 508, winning bids for the auctions during the time period can be determined. The winning bids can be determined from the bids of the advertisers respectively permitted to participate in each of the auctions.

Now referring to FIG. 6, illustrated is a methodology 600 that facilitates smoothing budgets of advertisers based on minimum return on investment values for the advertisers. At 602, bids for auctions during a time period from the advertisers can be received. The auctions can be, for instance, search-based keyword auctions. At 604, respective threshold minimum return on investment values for the advertisers can be received. At 606, participation profiles can be determined for each of the auctions based at least in part on the respective threshold minimum return on investment values for the advertisers and the bids for the auctions from the advertisers. For instance, a participation profile for a particular auction can include a first subset of the advertisers that participate in the particular auction and can exclude a second subset of the advertisers throttled from the particular auction. At 608, winning bids for the auctions during the time period can be determined. The winning bids can be determined from the bids of the advertisers respectively included in participation profiles for each of the auctions. Further, the respective threshold minimum return on investment values for the advertisers can be adjusted based on actual spend rates versus ideal spend rates for the advertisers.

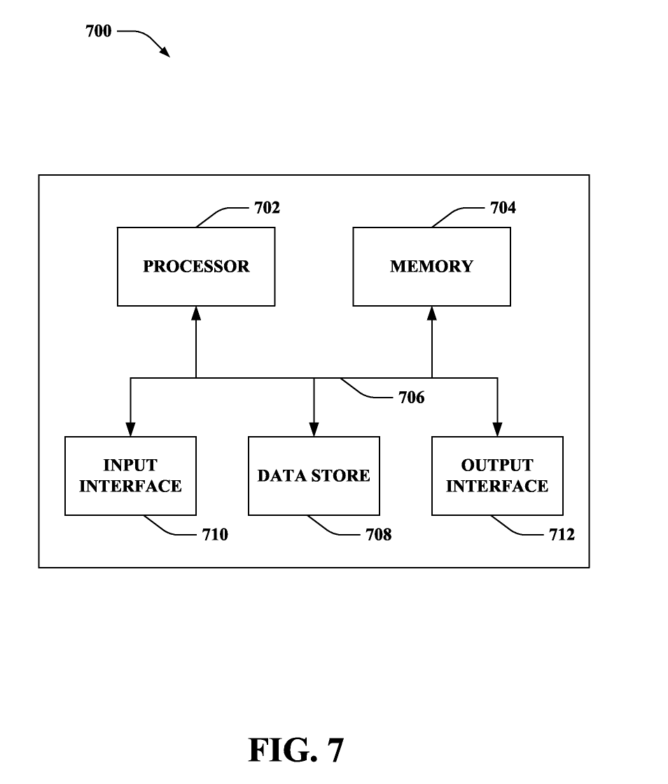

Referring now to FIG. 7, a high-level illustration of an exemplary computing device 700 that can be used in accordance with the systems and methodologies disclosed herein is illustrated. For instance, the computing device 700 may be used in a system that facilitates smoothing budgets of advertisers for online advertising during a time period. The computing device 700 includes at least one processor 702 that executes instructions that are stored in a memory 704. The instructions may be, for instance, instructions for implementing functionality described as being carried out by one or more components discussed above or instructions for implementing one or more of the methods described above. The processor 702 may access the memory 704 by way of a system bus 706. In addition to storing executable instructions, the memory 704 may also store budgets, bids, probability of click values, advertisements, threshold minimum return on investment values, mappings, scores, participation profiles, parameters, and so forth.

The computing device 700 additionally includes a data store 708 that is accessible by the processor 702 by way of the system bus 706. The data store 708 may include executable instructions, budgets, bids, probability of click values, advertisements, threshold minimum return on investment values, mappings, scores, participation profiles, parameters, etc. The computing device 700 also includes an input interface 710 that allows external devices to communicate with the computing device 700. For instance, the input interface 710 may be used to receive instructions from an external computer device, from a user, etc. The computing device 700 also includes an output interface 712 that interfaces the computing device 700 with one or more external devices. For example, the computing device 700 may display text, images, etc. by way of the output interface 712.

It is contemplated that the external devices that communicate with the computing device 700 via the input interface 710 and the output interface 712 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 700 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 700 may be a distributed system. Thus, for instance, several devices may be in communication by way of a network connection and may collectively perform tasks described as being performed by the computing device 700.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something.”

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method that is executed by a computer processor on a computing device, the method comprising:
receiving information that indicates respective budgets of advertisers for online advertising during a time period;
receiving bids for auctions during the time period from the advertisers;
for each of the auctions during the time period and for each of the advertisers, determining whether to one of throttle an advertiser from an auction or permit the advertiser to participate in the auction, wherein the determination satisfies equilibrium conditions between the advertisers based on the respective budgets of the advertisers and the bids for the auctions; and
from the bids of the advertisers respectively permitted to participate in each of the auctions, determining winning bids for the auctions during the time period.

2. The method of claim 1, wherein the equilibrium conditions between the advertisers based on the respective budgets of the advertisers and the bids for the auctions, which are satisfied when determining whether to one of throttle the advertiser from the auction or permit the advertiser to participate in the auction, comprise:
the advertiser is expected to spend less than or equal to a respective budget during the time period on a subset of the auctions in which the advertiser is permitted to participate and has a winning bid;
the advertiser is permitted to participate in the auction when the advertiser is expected to spend less than the respective budget during the time period;
the advertiser is permitted to participate in the auction when the advertiser is expected to exhaust the respective budget during the time period and disparate auctions from which the advertiser is throttled provide lower returns on investment for the advertiser; and
the advertiser is throttled from the auction when the advertiser is expected to exhaust the respective budget during the time period and disparate auctions in which the advertiser is permitted to participate provide higher returns on investment for the advertiser.

3. The method of claim 1, further comprising determining whether to one of throttle the advertiser or permit the advertiser to participate in the auction based on a threshold minimum return on investment value for the advertiser.

4. The method of claim 3, wherein the advertiser is permitted to participate in a subset of the auctions that each provide the advertiser with a return on investment greater than the threshold minimum return on investment value for the advertiser.

5. The method of claim 3, wherein the advertiser is throttled from a subset of the auctions that each provide the advertiser with a return on investment lower than or equal to the threshold minimum return on investment value for the advertiser.

6. The method of claim 1, wherein the auctions are at least one of generalized second-price auctions or Vickrey-Clarke-Groves auctions.

7. The method of claim 1, wherein determining whether to one of throttle the advertiser or permit the advertiser to participate in the auction for each of the auctions during the time period and for each of the advertisers further comprises:
receiving respective threshold minimum return on investment values for the advertisers; and
determining participation profiles for each of the auctions based at least in part on the respective threshold minimum return on investment values for the advertisers and the bids for the auctions from the advertisers, wherein a participation profile for a particular auction comprises a first subset of the advertisers that participate in the particular auction and excludes a second subset of the advertisers throttled from the particular auction.

8. The method of claim 7, wherein determining the participation profile for the particular auction further comprises:
receiving scores for each of the advertisers, wherein the scores are a function of the bids for the particular auction from the advertisers and probability of click values of the advertisers for the particular auction;
ranking the scores that are greater than a reserve price for the particular auction in a decreasing order of scores;
for each score in the decreasing order of scores from a lowest score to a highest score:
generating a mapping for an advertiser i corresponding to the score from the decreasing order of scores, wherein the mapping is a function of the respective threshold minimum return on investment values for the advertisers and returns on investment computed from scores in the decreasing order;
comparing the mapping for the advertiser i to a current minimum value; and
if the mapping for the advertiser i is less than the current minimum value, adding the advertiser i to the first subset of the advertisers that participate in the particular auction and setting the mapping for the advertiser i as the current minimum value.

9. The method of claim 8, wherein the mapping for the advertiser i is generated utilizing the following algorithm:
$$σ ( i ) = min {i}^{′} s . t . \frac{{v}_{i} ( j )}{{v}_{{i}^{′}} ( j )} > {α}_{i} ; σ ( i ) = ∞ if \frac{{v}_{i} ( j )}{{r}_{j}} \leq {α}_{i} ;$$
wherein σ(i) is the mapping for the advertiser i to one of infinity or an advertiser i′, wherein vᵢ (j) is a score for the advertiser i for an auction j, wherein v_{i′}(j) is a score for the advertiser i′ for the auction j, wherein the score for the advertiser i for the auction j is greater than the score for the advertiser i′ for the auction j in the decreasing order of scores, wherein αᵢ is a threshold minimum return on investment value for the advertiser i, wherein rⱼ is a reserve price for the auction j, and wherein the advertiser i′ is associated with a maximum score within the decreasing order of scores that provides a return on investment greater than the threshold minimum return on investment for the advertiser i.

10. The method of claim 7, further comprising adjusting the respective threshold minimum return on investment values for the advertisers based on actual spend rates versus ideal spend rates for the advertisers.

11. The method of claim 1, wherein an auctioneer for the auctions is at least one of a search engine or an exchange for display advertising.

12. The method of claim 1, further comprising rendering a graphical user interface on a display screen, wherein the graphical user interface comprises advertisements from the advertisers having the winning bids for a particular auction.

13. A system that facilitates smoothing budgets of advertisers, comprising:
a processor;
a memory that comprises a plurality of components that are executed by the processor, the plurality of components comprising:
a selective participation component that receives information that indicates respective budgets of advertisers for online advertising during a time period and bids for auctions during the time period from the advertisers, wherein the selective participation component determines whether to one of throttle an advertiser from an auction or permit the advertiser to participate in the auction for each of the actions during the time period and for each of the advertisers, wherein the determination satisfies equilibrium conditions between the advertisers based on the respective budgets of the advertisers and the bids for the auctions; and
an auction component that determines winning bids for the auctions during the time period, wherein the winning bids are determined from the bids of the advertisers respectively permitted to participate in each of the auctions.

14. The system of claim 13, wherein the equilibrium conditions between the advertisers based on the respective budgets of the advertisers and the bids for the auctions, which are satisfied when determining whether to one of throttle the advertiser from the auction or permit the advertiser to participate in the auction, comprise:
the advertiser is expected to spend less than or equal to a respective budget during the time period on a subset of the auctions in which the advertiser is permitted to participate and has a winning bid;
the advertiser is permitted to participate in the auction when the advertiser is expected to spend less than the respective budget during the time period;
the advertiser is permitted to participate in the auction when the advertiser is expected to exhaust the respective budget during the time period and disparate auctions from which the advertiser is throttled provide lower returns on investment for the advertiser; and
the advertiser is throttled from the auction when the advertiser is expected to exhaust the respective budget during the time period and disparate auctions in which the advertiser is permitted to participate provide higher returns on investment for the advertiser

15. The system of claim 13, wherein the selective participation component receives respective threshold minimum return on investment values for the advertisers and determines participation profiles for each of the auctions based at least in part on the respective threshold minimum return on investment values for the advertisers and the bids for the auctions from the advertisers, wherein a participation profile for a particular auction comprises a first subset of the advertisers that participate in the particular auction and excludes a second subset of the advertisers throttled from the particular auction.

16. The system of claim 15, further comprising a threshold computation component that adjusts the respective threshold minimum return on investment values for the advertisers based on actual spend rates versus ideal spend rates for the advertisers.

17. The system of claim 13, wherein an auctioneer for the auctions is at least one of a search engine or an exchange for display advertising.

18. The system of claim 13, wherein the auctions are at least one of generalized second-price auctions or Vickrey-Clarke-Groves auctions.

19. A computer-readable storage medium including computer-executable instructions that, when executed by a processor, cause the processor to perform acts including:
receiving bids for auctions during a time period from advertisers, wherein the auctions are search-based keyword auctions;
receiving respective threshold minimum return on investment values for the advertisers;
determining participation profiles for each of the auctions based at least in part on the respective threshold minimum return on investment values for the advertisers and the bids for the auctions from the advertisers, wherein a participation profile for a particular auction comprises a first subset of the advertisers that participate in the particular auction and excludes a second subset of the advertisers throttled from the particular auction; and
from the bids of the advertisers respectively included in the participation profiles for each of the auctions, determining winning bids for the auctions during the time period.

20. The computer-readable storage medium of claim 19, wherein the computer-executable instructions, when executed by the processor, further cause the processor to perform acts including:
adjusting the respective threshold minimum return on investment values for the advertisers based on actual spend rates versus ideal spend rates for the advertisers.
